(19) United States
(12) Patent Application Publication
(10) Pub. No.: US 2011/0240804 A1
(43) Pub. Date: Oct. 6, 2011

(54) Integrated aircraft

(76) Inventor: Nikolaos Kehayas, Athens (GR)

(21) Appl. No.: 13/064,521

(22) Filed: Mar. 30, 2011

Related U.S. Application Data
(60) Provisional application No. 61/282,797, filed on Apr. 1, 2010.

(51) Int. Cl. B64D 27/12

(52) U.S. Cl. 244/73 R

(57) ABSTRACT

In a jet aircraft according to the invention the jet engines are embedded in the wings and exhaust through fishtail diffuser ducts, from high aspect ratio nozzles located at a small control flap at the wing trailing edge. The jet engines are very-high bypass ratio geared turbofans operating at a lower than typical temperature. The jet aircraft according to the invention exhibits exceptionally low zero-lift drag leading to exceptionally high lift-to-drag ratios.

I claim the benefit of Provisional Application No 61/282,797 filed on 1 Apr.2010 and entitled “Integrated aircraft”

### BACKGROUND OF THE INVENTION

Since the late 1950s subsonic civil transport aircraft technology has advanced substantially. This advance has been evolutionary and, consequently, the basic aircraft configuration has remained unchanged. It has been suggested that the conventional aircraft configuration is nearing its full evolutionary potential and a departure in the form of a new configuration or technology, or a combination of both, is needed. As a result a number of alternative concepts have been put forward, such as the blended wing-body, non-planar wings, laminar flow control, unducted fan and powered lift. The invention relates to a powered lift design based on the jet flap concept in combination with a very-high bypass ratio geared turbofan operating at a lower than typical temperature. The combination leads to an-exceptionally high lift-to-drag ratio.

In a jet-flapped design some part or the whole of the exhaust jet of the engines emerges, through ducts, at the trailing edge of the wing in the form of a jet flap. Jet-flapped wings exhibit very high lift coefficients, at high values of jet momentum coefficient and jet deflection angle.

Aircraft designs using the jet flap concept for very high lift during take-off and landing, and sometimes also for propulsion, have been known for many years. However, the exceptionally low zero-lift drag attributes of the jet flap, resulting in exceptionally high lift-to-drag ratios, have not been truly recognized.

### BRIEF SUMMARY OF THE INVENTION

With a jet aircraft designed as presented and characterized herein, it is achieved that the jet flap concept in combination with a very-high bypass ratio geared turbofan, operating at a lower than typical temperature, is used to attain exceptionally low zero-lift drag, leading to exceptionally high lift-to-drag ratios. In addition, the combination provides the already known features of the jet flap concept:thrust needed to propel the aircraft and, by means of a small control flap, very high lift characteristics. Very high lift is attained at high values of jet momentum coefficient and deflection angle. Exceptionally high lift-to-drag ratios are attained at certain values of jet momentum coefficient and deflection angle.

A jet that will provide the thrust needed to propel the aircraft, satisfy the condition for maximum lift-to-drag ratio, and be as close to the aircraft speed for high propulsive efficiency, must have a velocity much lower than the velocity of the exhaust jet of typical turbofans. As a result, jet engines with very low exhaust jet velocity, and, consequently, very-high mass flow rate are required. Selecting a very-high bypass ratio and lowering the combustion temperature of a geared turbofan make possible nearly equal values of total pressure for the cold and the hot streams, a jet engine nozzle pressure ratio less than the critical and, in turn, jet velocity less than Mach 1 at the jet engine nozzle. This jet engine nozzle velocity is low due to the low jet temperature arising from the mixing of the very-high bypass cold flow with the hot core flow. By being subsonic it can be further reduced with the use of a subsonic diffuser in the form of a fishtail duct.

Therefore, a jet aircraft designed as presented and characterized herein offers superior performance in cruising conditions as well as in take-off and landing.

### BRIEF DESCRIPTION OF THE SEVERAL VIEWS OF THE DRAWINGS

The present invention will be more fully understood by the following description and the accompanying drawings which are given by way of illustration and thus are not limitative and wherein:

FIG. 1 shows a schematic plan view of the engines embedded in the wings, the air intakes, the diffuser fishtail ducts and the small control flaps,

FIG. 2 shows a schematic view of the engine exhaust, diffuser duct and small control flap.

### DETAILED DESCRIPTION OF THE INVENTION

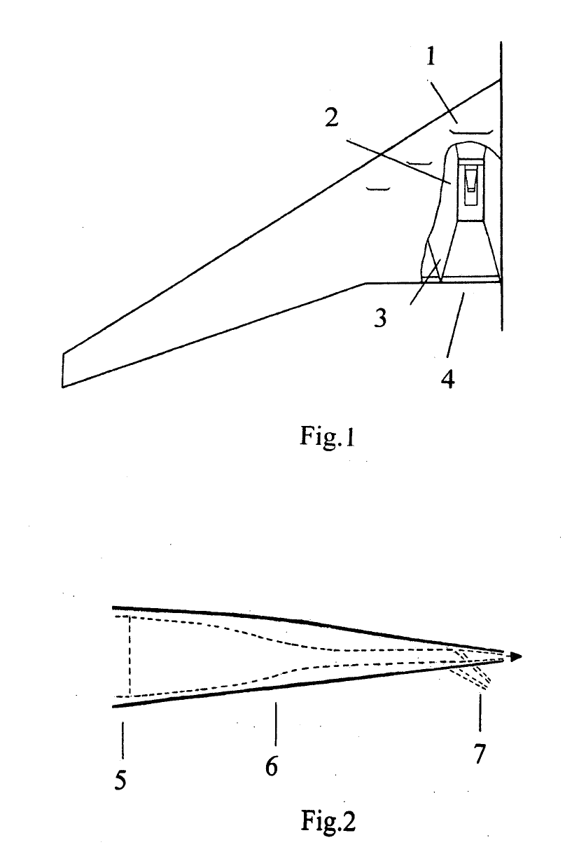

A jet aircraft, as schematically shown in FIGS. 1 and 2, incorporating a number of jet engines embedded in the wings 2, exhausting through fishtail diffuser ducts 3, from high aspect ratio two-dimensional nozzles located at a small control flap 4 at the trailing edge. The jet engines are positioned chordwise between the two wing spars 2. The engines are geared turbofans with a very-high bypass ratio and an operating temperature lower than typical, such that the exhaust nozzle flow is not choked. The engines air intakes 1 are situated in the upper surface of the wing. Inlet, s shape, ducts connect the air intakes to the engines.

The jet arising from the geared turbofan 5 and diffuser duct 6 combination has a velocity that provides towards the required thrust, satisfies the condition for maximum lift-to-drag ratio of the jet-flapped wings in cruising conditions and is close to the aircraft speed. The number of the embedded geared turbofans is a function of turbofan diameter, in order that the turbofans are fully embedded, and fishtail duct diffuser semi-angle, in order to avoid separation in the diffusers. The engines settings vary the jet momentum coefficient and the small control flap 7 varies the jet deflection angle. According to the values of the jet momentum coefficient and the jet deflection angle, very high lift characteristics, for take-off and landing, or exceptional lift-to drag ratios, for cruising conditions, are obtained.

I claim:

1. An aircraft in which the jet flap concept is used in combination with very-high bypass ratio geared turbofan jet engines, operating at a lower than typical temperature, in which a number of very-high bypass ratio geared turbofans are embedded in the wings, having intakes situated in the upper surface of the wings and connected to the engines by means of an s shape inlet ducts, and exhausting through fishtail diffuser ducts from high aspect ratio nozzles located at a small control flap at the wing trailing edge, achieving low exhaust jet velocities, because their exhaust nozzles are not working in choked conditions, which are further reduced in the diffuser ducts, leading to jet-flapped wings with exceptionally low zero-lift drag resulting in exceptionally high lift-to-drag ratios at certain values of jet momentum coefficient and jet deflection angle.

2. An aircraft according to claim 1 characterized in that altering the jet deflection angle, by means of a small control flap, and the jet momentum coefficient, by means of the engines settings, results in very high lift and eliminates the need for flaps.

3. An aircraft according to claim 1 characterized in that the jet flap provides for the thrust required, with very high trust recovery and propulsion efficiency.

4. An aircraft according to claim 1 characterized in that due to the engines being embedded in the wings, the low jet velocity of the jet flap, and the absence of flaps, noise is substantially reduced.

5. An aircraft according to claim 1 characterized in that due to the exceptionally high lift-to-drag ratio, resulting in exceptionally low fuel consumption, CO2 emissions are substantially reduced, and due to the fact that the very-high bypass ratio geared turbofans operate at a lower than typical temperature NOX emissions are substantially reduced.
